(19) United States
(12) Patent Application Publication
(10) Pub. No.: US 2026/0286142 A1
(43) Pub. Date: Sep. 24, 2026

(54) Method for preparing highly stable superhydrophobic composite material with flexible armor structure for metal corrosion prevention

(71) Applicant: Institute of Oceanology, Chinese Academy of Sciences, Qingdao City (CN)

(72) Inventors: Binbin ZHANG, Qingdao City (CN); Guangzhou LIANG, Qingdao City (CN)

(21) Appl. No.: 19/428,074

(22) Filed: Dec. 19, 2025

(30) Foreign Application Priority Data
Mar. 24, 2025 (CN) 2025103467038

(51) Int. Cl. C09D 5/08; B01J 2/30; B05D 7/14; C09D 7/62; C09D 175/06

(52) U.S. Cl. CPC C09D 5/08; B01J 2/30; B05D 7/14; C09D 7/62; C09D 175/06; C08K 2201/011

(57) ABSTRACT

The present disclosure belongs to the technical field of corrosion protection of metal materials in marine environments, and specifically relates to a method for preparing a highly stable superhydrophobic composite material with flexible armor structure for metal corrosion prevention in marine environments. The method includes: spraying a superhydrophobic suspension prepared by a phase separation method onto the surface of a flexible armor structure to obtain a highly stable superhydrophobic composite material with flexible armor structure for metal corrosion prevention after complete curing. A method for preparing the flexible armor structure includes: dispersing an adhesive in a diluent to obtain an adhesive diluent, spraying the above adhesive diluent onto the surface of a pre-treated substrate, and then, bonding flexible armor particles onto the surface of the above material for curing to obtain the flexible armor structure.

### CROSS-REFERENCE TO RELATED APPLICATIONS

This application claims priority to Chinese Patent Application No. 202510346703.8, filed on Mar. 24, 2025, which is incorporated herein by reference in its entirety.

### TECHNICAL FIELD

The present disclosure belongs to the field of corrosion protection of superhydrophobic metal materials in marine environments, and specifically relates to a method for preparing a highly stable superhydrophobic composite material with flexible armor structure for metal corrosion prevention in marine environments.

### BACKGROUND

Artificially designed and constructed biomimetic superhydrophobic materials are functional materials with non-wettability. As a new type of materials, superhydrophobic materials have use prospects in many fields due to waterproof and self-cleaning functions, especially in corrosion prevention and self-cleaning aspects of metal materials. The problem of metal corrosion in marine environments is extremely complex, such as corrosion problems of offshore oil well platforms, ships, and cross-sea bridges, leading to resource waste and even production safety problems. The problem of metal corrosion prevention in the current marine environment urgently needs to be solved. Therefore, superhydrophobic new materials can provide important use references for corrosion protection of metal materials.

In recent years, the artificial manufacturing of superhydrophobic materials has developed rapidly. However, as for the current reported work, the improvement of the mechanical stability of superhydrophobic anti-corrosion materials has always been an unresolved problem. Due to micro-nano rough structures on the surfaces of superhydrophobic materials and the sensitivity of low-surface superhydrophobic nanoparticles to mechanical external forces, the mechanical stability of superhydrophobic anti-corrosion materials is poor. Therefore, improving the mechanical stability of the surfaces of superhydrophobic anti-corrosion materials is crucial for practical uses.

### SUMMARY

In response to the problems of insufficient mechanical stability and the like in current superhydrophobic anti-corrosion materials, the present disclosure provides a method for preparing a highly stable superhydrophobic composite material with flexible armor structure for metal corrosion prevention, which can effectively improve the mechanical stability of superhydrophobic anti-corrosion coatings and effectively cope with the above problems in superhydrophobic anti-corrosion materials.

In order to achieve the above objectives, the present disclosure uses the following technical solutions:

A method for preparing a highly stable superhydrophobic composite material with flexible armor structure for metal corrosion prevention includes: spraying a superhydrophobic suspension onto the surface with flexible armor structure, and performing curing to prepare the highly stable superhydrophobic composite material with flexible armor structure for metal corrosion prevention.

A method for preparing the flexible armor structure includes: diluting an epoxy resin adhesive in an organic solvent to prepare an epoxy diluent, then spraying the epoxy diluent onto the surface of a pre-treated metal substrate by a spray method to prepare an epoxy adhesive layer, subsequently uniformly bonding flexible armor particles onto the surface of the epoxy adhesive layer, and performing curing to prepare the flexible armor structure.

The method specifically includes the following steps:
S1: preparation of superhydrophobic modified nanoparticles: ultrasonically dispersing hydrophilic nanoparticles in an organic solvent, and then, adding a low-surface-energy organosilane coupling agent under a stirring condition for superhydrophobic modification to obtain superhydrophobic modified nanoparticles;
S2: preparation of superhydrophobic suspension by phase separation method: completely dissolving polyester in the organic solvent, then adding the superhydrophobic modified nanoparticles under a stirring condition until the superhydrophobic modified nanoparticles are completely dispersed by stirring, adding a non-solvent to induce phase separation after the superhydrophobic nanoparticles are completely dispersed, and preparing a superhydrophobic suspension after the completion of phase separation;
S3: preparation of flexible armor structure: diluting an epoxy resin adhesive in the organic solvent to prepare an epoxy diluent, then spraying the epoxy diluent onto the surface of a pre-treated metal substrate by a spray method to prepare an epoxy adhesive layer, subsequently uniformly bonding flexible armor particles onto the surface of the epoxy adhesive layer, and performing curing to prepare a flexible armor structure; and
S4: preparation of highly stable superhydrophobic composite material with flexible armor structure for metal corrosion prevention: spraying the superhydrophobic suspension prepared in S2 onto the surface of the flexible armor structure prepared in S3 by a spray gun, and preparing a highly stable superhydrophobic composite material with the flexible armor structure for metal corrosion prevention after complete curing.

Further, in step S1, the nanoparticles are one or more of nano aluminum oxide particles, nano titanium dioxide particles, nano silicon dioxide particles, and nano zirconium dioxide particles; and the low-surface-energy organosilane coupling agent is one or more of 1H, 1H, 2H, 2H-perfluorodecyltrimethoxysilane, 1H, 1H, 2H, 2H-perfluorooctyltrimethoxysilane, or 1H, 1H, 2H, 2H-perfluorodecyltriethoxysilane.

Further, in step S1, the volume ratio of the low-surface-energy modified reagent to the organic solvent is 0.05:3-0.15:3, and the mass concentration of the nanoparticles is 0.10-0.30 g/mL.

Further, in step S1, the reaction condition for modification is reaction at a room temperature for 6-24 h, and a preferred temperature is 20-30° C.

Further, in step S2, the polyester is one or more of polyurethane (PU), thermoplastic polyurethane (TPU), and Si-modified polyester (Si-PU); the organic solvent used is one or more of ethyl acetate, butyl acetate, and acetone; and the mass concentration of the polyester is 0.01-0.10 g/mL.

Further, in step S2, the non-solvent required for inducing phase separation is anhydrous ethanol, and furthermore, the volume ratio of the non-solvent to the organic solvent is 0.10-0.20 mL/mL.

Further, in step S2, the mass concentration of the superhydrophobic modified nanoparticles is 0.01-0.10 g/mL.

Further, in step S3, the flexible armor particles are regenerated rubber particles from waste tires, the particle size is 60-65 meshes, and furthermore, the dosage of the flexible armor particles is 100-300 g/m².

Further, in step S3, the epoxy resin adhesive is formed by mixing epoxy resin and a curing agent in a mass ratio of 1:1, wherein the curing agent is polyamide (650), polyether amine (D230), diethylenetriamine (DETA), or γ-aminopropyltriethoxysilane (KH-550).

Further, in step S3, the mass fraction of the epoxy resin adhesive in the epoxy diluent is 20%-30%.

Further, in step S3, the substrate material is carbon steel, copper sheet, titanium sheet, aluminum alloy, stainless steel, or magnesium alloy.

Further, in step S4, the superhydrophobic suspension is sprayed onto the surface of the flexible armor structure by a spray method, and furthermore, the dosage of the superhydrophobic suspension is 0.60-1.20 mL/cm².

Compared with the prior art, the present disclosure has the following advantages:

1. In the highly stable superhydrophobic composite material with flexible armor structure for metal corrosion prevention prepared in the present disclosure, the bottommost layer is an epoxy adhesive material directly bonded to the pre-treated substrate, which can effectively fix flexible armor particles onto the surface of the substrate; the middle is a flexible armor particle material, which can provide a buffering effect on an external force to prevent a superhydrophobic layer on an inner surface of a groove structure from being damaged; and the surface superhydrophobic material is a superhydrophobic layer obtained by spraying a superhydrophobic suspension prepared by a phase separation method, which has an effect of providing superhydrophobicity.

2. In the highly stable superhydrophobic composite material with flexible armor structure for metal corrosion prevention prepared in the present disclosure, the superhydrophobic layer and the flexible armor structure are combined to construct a micro-nano-graded rough structure with ultra-high roughness and ultra-low surface free energy required for a superhydrophobic coating material; and the synergistic effect of the superhydrophobic layer and the flexible armor structure not only endows the composite material coating with excellent superhydrophobic performance, but also effectively improves the mechanical stability and durability of the composite material coating. In the groove structure of the flexible armor structure, the superhydrophobic suspension is sprayed by a spray method to prepare the superhydrophobic layer. When the coating is subjected to an external force, the flexible armor structure effectively protects the superhydrophobic layer to reduce the degree of damage to the superhydrophobic layer due to the external force, thereby effectively improving the superhydrophobic mechanical stability and durability of the composite material coating.

3. Through water droplet contact angle and rolling angle tests, the highly stable superhydrophobic composite material with flexible armor structure for metal corrosion prevention prepared in the present disclosure shows excellent superhydrophobic performance; and the highly stable superhydrophobic composite material with flexible armor structure for metal corrosion prevention prepared in the present disclosure can be applied to surfaces of various metal substrates, and shows excellent superhydrophobic performance.

4. Through durability tests (including a wear resistance test of the coating with 2000-mesh sandpaper under a load condition of 100 g and a tape stripping test under a load of 100 g), it is verified that the highly stable superhydrophobic composite material with flexible armor structure for metal corrosion prevention prepared in the present disclosure has higher stability.

5. Through corrosion resistance tests (including an electrochemical impedance spectroscopy (EIS) test, a real marine atmospheric environment exposure test, etc.), it is verified that the coating of the highly stable superhydrophobic composite material with flexible armor structure for metal corrosion prevention prepared in the present disclosure has better corrosion resistance on the surface of a metal substrate material.

6. The highly stable superhydrophobic composite material with flexible armor structure for metal corrosion prevention prepared in the present disclosure has the advantages of simple preparation technology, easy operation, high efficiency, etc., and is of great significance for practical production of superhydrophobic composite materials.

### BRIEF DESCRIPTION OF THE DRAWINGS

FIG. 1 is a schematic structural diagram of a composite material coating prepared in the present disclosure; and

FIG. 2 is a diagram showing an ordinary optical photograph, a contact angle, and a rolling angle of water droplets on the surface of a composite material coating sample prepared in Example 1 of the present disclosure.

### DETAILED DESCRIPTION OF THE EMBODIMENTS

The present disclosure will be described in detail below with reference to specific examples. The following examples will help those skilled in the art further understand the present disclosure, but do not limit the present disclosure in any form. It should be noted that those of ordinary skill in the art can make changes and improvements without departing from the inventive concept. These are all within the scope of protection of the present disclosure.

In the present disclosure, flexible rubber particles and an adhesive are combined to construct a flexible armor structure on the surface of a substrate, which can effectively resist the damage of an external force to a rough surface structure of a superhydrophobic composite material, so as to improve the stability and durability of the superhydrophobic composite material coating, so that the overall microstructure integrity and superhydrophobic performance of the coating can become more durable. Through the synergistic effect of a superhydrophobic material and a flexible armor structure material, the composite material coating has better mechanical stability and superhydrophobic performance.

According to the method for preparing a highly stable superhydrophobic composite material with flexible armor structure for metal corrosion prevention in the present disclosure, a superhydrophobic surface-layer suspension is sprayed onto the surface of the flexible armor structure to obtain the material after complete curing.

A method for preparing the flexible armor structure includes: an adhesive is diluted in an organic solvent to prepare a diluent, then the diluent is sprayed onto the surface of a pre-treated metal substrate by a spray method to prepare an adhesive layer, subsequently flexible armor particles are uniformly bonded onto the surface of the adhesive layer, and curing is performed to prepare the flexible armor structure.

The method specifically includes the following steps:
S1: preparation of superhydrophobic modified nanoparticles: hydrophilic nanoparticles are ultrasonically dispersed in an organic solvent, and then, a low-surface-energy organosilane coupling agent is added under a stirring condition for superhydrophobic modification to obtain superhydrophobic modified nanoparticles;
S2: preparation of superhydrophobic suspension by phase separation method: polyester is completely dissolved in the organic solvent, then the superhydrophobic modified nanoparticles are added under a stirring condition until the superhydrophobic modified nanoparticles are completely dispersed by stirring, a non-solvent is added to induce phase separation after the superhydrophobic nanoparticles are completely dispersed, and a superhydrophobic suspension is prepared after the completion of phase separation;
S3: preparation of flexible armor structure: an epoxy resin adhesive is diluted in the organic solvent to prepare an epoxy diluent, then the epoxy diluent is sprayed onto the surface of a pre-treated metal substrate by a spray method to prepare an epoxy adhesive layer, subsequently flexible armor particles are uniformly bonded onto the surface of the epoxy adhesive layer, and curing is performed to prepare a flexible armor structure; and
S4: preparation of highly stable superhydrophobic composite material with flexible armor structure for metal corrosion prevention: the superhydrophobic suspension prepared in S2 is sprayed onto the surface of the flexible armor structure prepared in S3 by a spray gun, and a highly stable superhydrophobic composite material with flexible armor structure for metal corrosion prevention is prepared after complete curing.

A method for pre-treating a metal substrate includes: the surface of the metal substrate is respectively polished with 800-mesh SiC sandpaper and 1500-mesh SiC sandpaper, then the metal substrate is immersed in ethanol and ultrasonically cleaned for 20 min, then the metal substrate is ultrasonically cleaned with deionized water for 3 times (each time of ultrasonic cleaning lasts 10 min), and the metal substrate is blow-dried for later use. In the present disclosure, for ease of comparison, only Example 3 uses an A5052 aluminum alloy metal substrate, while the other examples all use a Q235 carbon steel metal substrate for preparation and testing. In practical situations, metal material substrates such as stainless steel, aluminum alloy, and magnesium alloy can also be used. Examples and Comparative Examples all use ethanol as a solvent. In practical situations, one or more of ethanol, ethyl acetate, and butyl acetate can also be used. The present disclosure is not limited thereto. The solvents and raw materials used in the examples are all commercially available. The flexible armor particles are regenerated rubber particles from waste tires, purchased from Chenqi environmental protection raw materials.

### Specific Implementation Solutions:

### Example 1

S1: Preparation of superhydrophobic modified nanoparticles: 5.0 g of hydrophilic metal-based nano aluminum oxide particles were dispersed in 30 mL of ethanol and ultrasonically dispersed for 20 min, then 1.0 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

S2: Preparation of superhydrophobic suspension by phase separation method: 0.2 g of thermoplastic polyurethane elastomer particles were completely dissolved in 12 mL of ethyl acetate. Then, 0.25 g of superhydrophobic nano aluminum oxide particles were added, and magnetic stirring was performed for 3 h to uniformly disperse the superhydrophobic nano aluminum oxide particles. Then, 2 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

S3: Preparation of flexible armor structure: Anhydrous ethanol was used as a diluting solvent to prepare a diluent of an adhesive E44 and a curing agent polyamide (the mass ratio of E44 to polyamide was 1:1). At an air pressure of 0.3 MPa, the diluent was sprayed onto the surface of a Q235 carbon steel substrate to prepare an adhesive layer. Then, regenerated rubber particles from waste tires of 60-65 meshes were uniformly bonded on the surface (the dosage of the rubber particles was 268 g/m²), and a flexible armor structure was constructed after the rubber particles were completely cured.

S4: Preparation of highly stable superhydrophobic composite material with flexible armor structure for metal corrosion prevention: The superhydrophobic suspension prepared in S2 was sprayed onto the surface of the flexible armor structure prepared in S3 by a spray gun (the spraying pressure was 0.3 MPa, the spraying distance was 15 cm, and the dosage of the suspension was 1.0 mL/cm²), and a highly stable superhydrophobic composite material with flexible armor structure for metal corrosion prevention was prepared after complete curing.

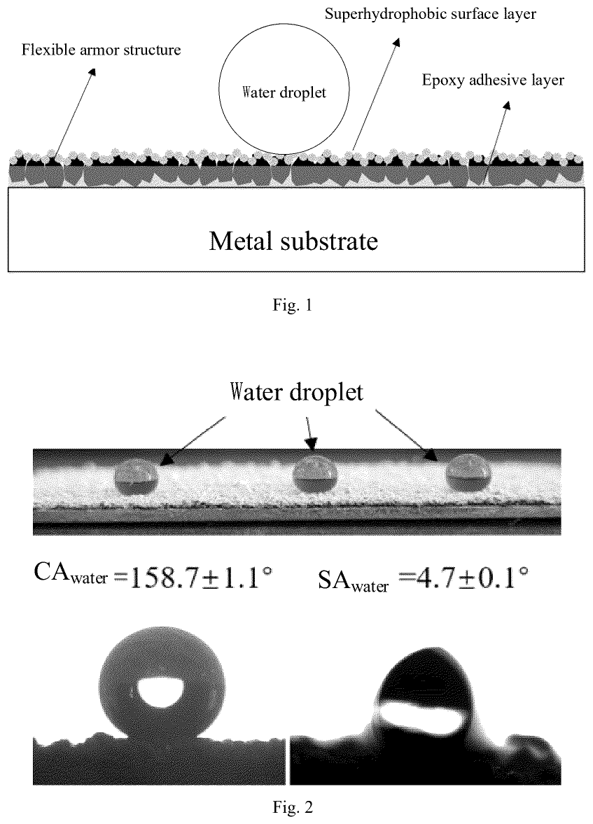

A performance test method of the prepared highly stable superhydrophobic composite material with flexible armor structure for metal corrosion prevention (schematic structural diagram was shown in FIG. 1):

I. Wetting performance test of composite material coating: a contact angle measuring instrument was used for measuring a contact angle and a rolling angle of water droplets on a coating surface to determine the superhydrophobic performance of a prepared coating, wherein the droplets, contact angle and rolling angle were shown in FIG. 2.

II. Mechanical stability test of composite material coating: (1) Sandpaper wear test: After the prepared coating sample was worn with 2000-mesh sandpaper under a load condition of 100 g, the contact angle measuring instrument was used for measuring a contact angle and a rolling angle of water droplets to determine the superhydrophobic performance of the worn prepared coating, so as to evaluate the mechanical stability thereof. (2) Tape stripping test: A 3M tape was stuck onto the surface of the prepared coating sample, compacted under a load condition of 100 g and quickly stripped, and then, the contact angle measuring instrument was used for measuring a contact angle and a rolling angle of water droplets to determine the superhydrophobic performance of the worn prepared coating, so as to evaluate the mechanical stability thereof.

III. Corrosion resistance test-electrochemical impedance spectroscopy test of composite material coating: A three-electrode system was used in a 3.5 wt. % NaCl aqueous solution system, wherein a platinum sheet electrode was used as a counter electrode, an Ag/AgCl electrode was used as a reference electrode, a composite material coating with an exposed area of 1 cm² (substrate was Q235 carbon steel) was used as a working electrode, and an electrochemical impedance spectroscopy test was performed by an electrochemical workstation to determine the electrochemical performance of the prepared coating. Performance test results of Example 1:

1. Wetting performance of composite material coating: The contact angle and rolling angle of the water droplets on the coating surface were measured by the contact angle measuring instrument, the water contact angle of the coating surface was 158.7=1.1°, and the rolling angle was 4.7±0.1° (see FIG. 2). It can be seen that the prepared highly stable superhydrophobic composite material with flexible armor structure for metal corrosion prevention shows an excellent superhydrophobic characteristic.

2. Mechanical stability test of composite material coating: (1) After the coating was worn for 1200 times with 2000-mesh sandpaper under a load condition of 100 g, the contact angle of the water droplets was greater than 150°, and the rolling angle was less than 10°. Specifically, after the coating was worn for 100 times, the water contact angle of the coating was 155.3±0.3°, and the rolling angle was 5.0±0.3°; after the coating was worn for 300 times, the water contact angle of the coating was 154.4±0.7°, and the rolling angle was 5.7±0.3°; after the coating was worn for 600 times, the water contact angle of the coating was 154.0±1.2°, and the rolling angle was 5.6±0.1°; after the coating was worn for 900 times, the water contact angle of the coating was 153.9±0.7°, and the rolling angle was 5.3±0.3°; and after the coating was worn for 1200 times, the water contact angle of the coating was 150.1±0.6°, and the rolling angle was 9.2±0.4°. It can be seen that the prepared highly stable superhydrophobic composite material with flexible armor structure for metal corrosion prevention still shows a better superhydrophobic characteristic for the water droplets after being worn for 1200 times with the sandpaper, and has excellent mechanical wear resistance. (2) After the coating was stripped for 450 times with a 3M tape, the contact angle of the water droplets was greater than 150°, and the rolling angle was less than 10°. Specifically, after the coating was stripped for 50 times, the water contact angle of the coating was 154.7±0.3°, and the rolling angle was 5.0±0.2°; after the coating was stripped for 100 times, the water contact angle of the coating was 153.6±0.6°, and the rolling angle was 5.0=0.1°; after the coating was stripped for 200 times, the water contact angle of the coating was 153.0±0.6°, and the rolling angle was 5.1±0.2°; after the coating was stripped for 300 times, the water contact angle of the coating was 152.4±1.0°, and the rolling angle was 6.8±0.2°; and after the coating was stripped for 450 times, the water contact angle of the composite material coating was 150.0±0.2°, and the rolling angle was 9.4±0.4°. It can be seen that the prepared highly stable superhydrophobic composite material with flexible armor structure for metal corrosion prevention still shows a better superhydrophobic characteristic for the water droplets after being stripped for 450 times with the 3M tape, and has excellent coating adhesion.

3. Corrosion resistance test-electrochemical impedance spectroscopy test of composite material coating: The results showed that the charge transfer resistance of the coating was R_{ct}=9.53×10¹⁰ Ωcm², which was increased by 7 orders of magnitude compared to a blank Q235 carbon steel substrate (R_{ct}=1.18×10³ Ωcm²), showing better anti-corrosion and corrosion-resistant performance.

### Example 2

S1: Preparation of superhydrophobic modified nanoparticles: 5.0 g of superhydrophilic nano titanium dioxide particles were dispersed in 30 mL of ethanol and ultrasonically dispersed for 20 min, then 1.0 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic nano titanium dioxide particles through fluorosilane hydrolytic condensation reaction), and the obtained suspension was dried to prepare superhydrophobic nano titanium dioxide particles.

S2: Preparation of superhydrophobic suspension by phase separation method: 0.2 g of thermoplastic polyurethane elastomer particles were completely dissolved in 12 mL of ethyl acetate. Then, 0.25 g of superhydrophobic nano titanium dioxide particles were added, and magnetic stirring was performed for 3 h to uniformly disperse the superhydrophobic nano titanium dioxide particles. Then, 2 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

S3: Preparation of flexible armor structure: Anhydrous ethanol was used as a diluting solvent to prepare a diluent of an adhesive E44 and a curing agent polyamide (the mass ratio of E44 to polyamide was 1:1). At an air pressure of 0.3 MPa, the diluent was sprayed onto the surface of a Q235 carbon steel substrate to prepare an adhesive layer. Then, regenerated rubber particles from waste tires of 60-65 meshes were uniformly bonded on the surface (the dosage of the rubber particles was 268 g/m²), and a flexible armor structure was constructed after the rubber particles were completely cured.

S4: Preparation of highly stable superhydrophobic composite material with flexible armor structure for metal corrosion prevention: The superhydrophobic suspension prepared in S2 was sprayed onto the surface of the flexible armor structure prepared in S3 by a spray gun (the spraying pressure was 0.3 MPa, the spraying distance was 15 cm, and the dosage of the suspension was 1.0 mL/cm²), and a highly stable superhydrophobic composite material with flexible armor structure for metal corrosion prevention was prepared after complete curing.

The performance test method of the highly stable superhydrophobic composite material with flexible armor structure for metal corrosion prevention obtained in Example 2 was the same as that in Example 1. Test results were:

1. Wetting performance of composite material coating: The contact angle and rolling angle of the water droplets on the coating surface were measured by the contact angle measuring instrument, the water contact angle of the coating surface was 157.1°, and the rolling angle was 4.3°. It can be seen that the prepared highly stable superhydrophobic composite material with flexible armor structure for metal corrosion prevention shows an excellent superhydrophobic characteristic.

2. Mechanical stability test of composite material coating: (1) After the coating was worn for 1200 times with 2000-mesh sandpaper under a load condition of 100 g, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being worn for 1200 times with the sandpaper, and has excellent mechanical wear resistance. (2) After the coating was stripped for 450 times with a 3M tape, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being stripped for 450 times with the 3M tape, and has excellent coating adhesion.

3. Corrosion resistance test-electrochemical impedance spectroscopy test of composite material coating: The results showed that the charge transfer resistance of the coating was R_{ct}=8.74×10¹⁰ Ωcm², which was increased by 7 orders of magnitude compared to a blank Q235 carbon steel substrate (R_{ct}=1.18×10³ Ωcm²), showing better anti-corrosion and corrosion-resistant performance.

### Example 3

S1: Preparation of superhydrophobic modified nanoparticles: 5.0 g of hydrophilic metal-based nano aluminum oxide particles were dispersed in 30 mL of ethanol and ultrasonically dispersed for 20 min, then 1.0 mL of 1H, 1H, 2H, 2H-perfluorooctyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

S2: Preparation of superhydrophobic suspension by phase separation method: 0.2 g of thermoplastic polyurethane elastomer particles were completely dissolved in 12 mL of ethyl acetate. Then, 0.25 g of superhydrophobic nano aluminum oxide particles were added and magnetically stirred for 3 h to uniformly disperse the superhydrophobic nano aluminum oxide particles. Then, 2 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

S3: Preparation of flexible armor structure: Anhydrous ethanol was used as a diluting solvent to prepare a diluent of an adhesive E44 and a curing agent polyamide (the mass ratio of E44 to polyamide was 1:1). At an air pressure of 0.3 MPa, the diluent was sprayed onto the surface of a Q235 carbon steel substrate to prepare an adhesive layer. Then, regenerated rubber particles from waste tires of 60-65 meshes were uniformly bonded on the surface (the dosage of the rubber particles was 268 g/m²), and a flexible armor structure was constructed after the rubber particles were completely cured.

S4: Preparation of highly stable superhydrophobic composite material with flexible armor structure for metal corrosion prevention: The superhydrophobic suspension prepared in S2 was sprayed onto the surface of the flexible armor structure prepared in S3 by a spray gun (the spraying pressure was 0.3 MPa, the spraying distance was 15 cm, and the dosage of the suspension was 1.0 mL/cm²), and a highly stable superhydrophobic composite material with flexible armor structure for metal corrosion prevention was prepared after complete curing.

The performance test method of the highly stable superhydrophobic composite material with flexible armor structure for metal corrosion prevention obtained in Example 3 was the same as that in Example 1. Test results were:

1. Wetting performance of coating: The contact angle and rolling angle of the water droplets on the coating surface were measured by the contact angle measuring instrument, the water contact angle of the coating surface was 156.6°, and the rolling angle was 5.1°. It can be seen that the prepared highly stable superhydrophobic composite material with flexible armor structure for metal corrosion prevention shows an excellent superhydrophobic characteristic.

2. Mechanical stability test of coating: (1) After the coating was worn for 1200 times with 2000-mesh sandpaper under a load condition of 100 g, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being worn for 1200 times with the sandpaper, and has excellent mechanical wear resistance. (2) After the coating was stripped for 450 times with a 3M tape, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being stripped for 450 times with the 3M tape, and has excellent coating adhesion.

3. Corrosion resistance test-electrochemical impedance spectroscopy test of coating: The results showed that the charge transfer resistance of the coating was R_{ct}=9.62×10⁹ Ωcm², which was increased by 6 orders of magnitude compared to a Q235 carbon steel substrate (R_{ct}=1.18×10³ Ωcm²), showing better anti-corrosion and corrosion-resistant performance.

### Example 4

S1: Preparation of superhydrophobic modified nanoparticles: 5.0 g of hydrophilic metal-based nano aluminum oxide particles were dispersed in 30 mL of ethanol and ultrasonically dispersed for 20 min, then 1.0 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

S2: Preparation of superhydrophobic suspension by phase separation method: 0.2 g of thermoplastic polyurethane elastomer particles were completely dissolved in 12 mL of ethyl acetate. Then, 0.25 g of superhydrophobic nano aluminum oxide particles were added and magnetically stirred for 3 h to uniformly disperse the superhydrophobic nano aluminum oxide particles. Then, 2 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

S3: Preparation of flexible armor structure: Anhydrous ethanol was used as a diluting solvent to prepare a diluent of an adhesive E44 and a curing agent polyamide (the mass ratio of E44 to polyamide was 1:1). At an air pressure of 0.3 MPa, the diluent was sprayed onto the surface of an A5083 aluminum alloy substrate to prepare an adhesive layer. Then, regenerated rubber particles from waste tires of 60-65 meshes were uniformly bonded on the surface (the dosage of the rubber particles was 268 g/m²), and a flexible armor structure was constructed after the rubber particles were completely cured.

S4: Preparation of highly stable superhydrophobic composite material with flexible armor structure for metal corrosion prevention: The superhydrophobic suspension prepared in S2 was sprayed onto the surface of the flexible armor structure prepared in S3 by a spray gun (the spraying pressure was 0.3 MPa, the spraying distance was 15 cm, and the dosage of the suspension was 1.0 mL/cm²), and a highly stable superhydrophobic composite material with flexible armor structure for metal corrosion prevention was prepared after complete curing.

The performance test method of the highly stable superhydrophobic composite material with flexible armor structure for metal corrosion prevention obtained in Example 4 was the same as that in Example 1. Test results were:

1. Wetting performance of coating: The contact angle and rolling angle of the water droplets on the coating surface were measured by the contact angle measuring instrument, the water contact angle of the coating surface was 158.2°, and the rolling angle was 4.6°. It can be seen that the prepared highly stable superhydrophobic composite material with flexible armor structure for metal corrosion prevention shows an excellent superhydrophobic characteristic.

2. Mechanical stability test of coating: (1) After the coating was worn for 1200 times with 2000-mesh sandpaper under a load condition of 100 g, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being worn for 1200 times with the sandpaper, and has excellent mechanical wear resistance. (2) After the coating was stripped for 450 times with a 3M tape, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being stripped for 450 times with the 3M tape, and has excellent coating adhesion.

3. Corrosion resistance test-electrochemical impedance spectroscopy test of coating: The results showed that the charge transfer resistance of the coating was R_{ct}=1.21×10¹¹ Ωcm², which was increased by 7 orders of magnitude compared to a blank A5083 aluminum alloy substrate (R_{ct}=1.25×10⁴ Ωcm²), showing better anti-corrosion and corrosion-resistant performance.

### Example 5

S1: Preparation of superhydrophobic modified nanoparticles: 5.0 g of hydrophilic metal-based nano aluminum oxide particles were dispersed in 30 mL of ethanol and ultrasonically dispersed for 20 min, then 1.0 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

S2: Preparation of superhydrophobic suspension by phase separation method: 0.2 g of Si-modified polyurethane (Si-PU) was completely dissolved in 12 mL of ethyl acetate. Then, 0.25 g of superhydrophobic nano aluminum oxide particles were added and magnetically stirred for 3 h to uniformly disperse the superhydrophobic nano aluminum oxide particles. Then, 2 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

S3: Preparation of flexible armor structure: Anhydrous ethanol was used as a diluting solvent to prepare a diluent of an adhesive E44 and a curing agent polyamide (the mass ratio of E44 to polyamide was 1:1). At an air pressure of 0.3 MPa, the diluent was sprayed onto the surface of a Q235 carbon steel substrate to prepare an adhesive layer. Then, regenerated rubber particles from waste tires of 60-65 meshes were uniformly bonded on the surface (the dosage of the rubber particles was 268 g/m²), and a flexible armor structure was constructed after the rubber particles were completely cured.

S4: Preparation of highly stable superhydrophobic composite material with flexible armor structure for metal corrosion prevention: The superhydrophobic suspension prepared in S2 was sprayed onto the surface of the flexible armor structure prepared in S3 by a spray gun (the spraying pressure was 0.3 MPa, the spraying distance was 15 cm, and the dosage of the suspension was 1.0 mL/cm²), and a highly stable superhydrophobic composite material with flexible armor structure for metal corrosion prevention was prepared after complete curing.

The performance test method of the highly stable superhydrophobic composite material with flexible armor structure for metal corrosion prevention obtained in Example 5 was the same as that in Example 1. Test results were:

1. Wetting performance of coating: The contact angle and rolling angle of the water droplets on the coating surface were measured by the contact angle measuring instrument, the water contact angle of the coating surface was 157.8°, and the rolling angle was 4.8°. It can be seen that the prepared highly stable superhydrophobic composite material with flexible armor structure for metal corrosion prevention shows an excellent superhydrophobic characteristic.

2. Mechanical stability test of coating: (1) After the coating was worn for 1200 times with 2000-mesh sandpaper under a load condition of 100 g, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being worn for 1200 times with the sandpaper, and has excellent mechanical wear resistance. (2) After the coating was stripped for 450 times with a 3M tape, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being stripped for 450 times with the 3M tape, and has excellent coating adhesion.

3. Corrosion resistance test-electrochemical impedance spectroscopy test of coating: The results showed that the charge transfer resistance of the coating was R_{ct}=8.23×10¹⁰ Ωcm², which was increased by 7 orders of magnitude compared to a blank Q235 carbon steel substrate (R_{ct}-1.18×10³ Ωcm²), showing better anti-corrosion and corrosion-resistant performance.

### Example 6

S1: Preparation of superhydrophobic modified nanoparticles: 15.0 g of hydrophilic metal-based nano aluminum oxide particles were dispersed in 100 mL of ethanol and ultrasonically dispersed for 20 min, then 5.0 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

S2: Preparation of superhydrophobic suspension by phase separation method: 0.2 g of thermoplastic polyurethane elastomer particles were completely dissolved in 12 mL of ethyl acetate. Then, 0.25 g of superhydrophobic nano aluminum oxide particles were added and magnetically stirred for 3 h to uniformly disperse the superhydrophobic nano aluminum oxide particles. Then, 2 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

S3: Preparation of flexible armor structure: Anhydrous ethanol was used as a diluting solvent to prepare a diluent of an adhesive E44 and a curing agent polyamide (the mass ratio of E44 to polyamide was 1:1). At an air pressure of 0.3 MPa, the diluent was sprayed onto the surface of a Q235 carbon steel substrate to prepare an adhesive layer. Then, regenerated rubber particles from waste tires of 60-65 meshes were uniformly bonded on the surface (the dosage of the rubber particles was 268 g/m²), and a flexible armor structure was constructed after the rubber particles were completely cured.

S4: Preparation of highly stable superhydrophobic composite material with flexible armor structure for metal corrosion prevention: The superhydrophobic suspension prepared in S2 was sprayed onto the surface of the flexible armor structure prepared in S3 by a spray gun (the spraying pressure was 0.3 MPa, the spraying distance was 15 cm, and the dosage of the suspension was 1.0 mL/cm²), and a highly stable superhydrophobic composite material with flexible armor structure for metal corrosion prevention was prepared after complete curing.

The performance test method of the highly stable superhydrophobic composite material with flexible armor structure for metal corrosion prevention obtained in Example 6 was the same as that in Example 1. Test results were:

1. Wetting performance of coating: The contact angle and rolling angle of the water droplets on the coating surface were measured by the contact angle measuring instrument, the water contact angle of the coating surface was 158.4°, and the rolling angle was 4.3°. It can be seen that the prepared highly stable superhydrophobic composite material with flexible armor structure for metal corrosion prevention shows an excellent superhydrophobic characteristic.

2. Mechanical stability test of coating: (1) After the coating was worn for 1200 times with 2000-mesh sandpaper under a load condition of 100 g, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being worn for 1200 times with the sandpaper, and has excellent mechanical wear resistance. (2) After the coating was stripped for 450 times with a 3M tape, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being stripped for 450 times with the 3M tape, and has excellent coating adhesion.

3. Corrosion resistance test-electrochemical impedance spectroscopy test of coating: The results showed that the charge transfer resistance of the coating was R_{ct}=9.15×10¹⁰ Ωcm², which was increased by 7 orders of magnitude compared to a blank Q235 carbon steel substrate (R_{ct}=1.18×10³ Ωcm²), showing better anti-corrosion and corrosion-resistant performance.

### Example 7

S1: Preparation of superhydrophobic modified nanoparticles: 5.0 g of hydrophilic metal-based nano aluminum oxide particles were dispersed in 30 mL of ethanol and ultrasonically dispersed for 20 min, then 1.0 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

S2: Preparation of superhydrophobic suspension by phase separation method: 0.2 g of thermoplastic polyurethane elastomer particles were completely dissolved in 12 mL of ethyl acetate. Then, 0.25 g of superhydrophobic nano aluminum oxide particles were added and magnetically stirred for 3 h to uniformly disperse the superhydrophobic nano aluminum oxide particles. Then, 1.5 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

S3: Preparation of flexible armor structure: Anhydrous ethanol was used as a diluting solvent to prepare a diluent of an adhesive E44 and a curing agent polyamide (the mass ratio of E44 to polyamide was 1:1). At an air pressure of 0.3 MPa, the diluent was sprayed onto the surface of a Q235 carbon steel substrate to prepare an adhesive layer. Then, regenerated rubber particles from waste tires of 60-65 meshes were uniformly bonded on the surface (the dosage of the rubber particles was 268 g/m²), and a flexible armor structure was constructed after the rubber particles were completely cured.

S4: Preparation of highly stable superhydrophobic composite material with flexible armor structure for metal corrosion prevention: The superhydrophobic suspension prepared in S2 was sprayed onto the surface of the flexible armor structure prepared in S3 by a spray gun (the spraying pressure was 0.3 MPa, the spraying distance was 15 cm, and the dosage of the suspension was 1.0 mL/cm²), and a highly stable superhydrophobic composite material with flexible armor structure for metal corrosion prevention was prepared after complete curing.

The performance test method of the highly stable superhydrophobic composite material with flexible armor structure for metal corrosion prevention obtained in Example 7 was the same as that in Example 1. Test results were:

1. Wetting performance of coating: The contact angle and rolling angle of the water droplets on the coating surface were measured by the contact angle measuring instrument, the water contact angle of the coating surface was 156.5°, and the rolling angle was 5.3°. It can be seen that the prepared highly stable superhydrophobic composite material with flexible armor structure for metal corrosion prevention shows an excellent superhydrophobic characteristic.

2. Mechanical stability test of coating: (1) After the coating was worn for 1200 times with 2000-mesh sandpaper under a load condition of 100 g, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being worn for 1200 times with the sandpaper, and has excellent mechanical wear resistance. (2) After the coating was stripped for 450 times with a 3M tape, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being stripped for 450 times with the 3M tape, and has excellent coating adhesion.

3. Corrosion resistance test-electrochemical impedance spectroscopy test of coating: The results showed that the charge transfer resistance of the coating was R_{ct}=8.07×10¹⁰ Ωcm², which was increased by 7 orders of magnitude compared to a blank Q235 carbon steel substrate (R_{ct}=1.18×10³ Ωcm²), showing better anti-corrosion and corrosion-resistant performance.

### Example 8

S1: Preparation of superhydrophobic modified nanoparticles: 5.0 g of hydrophilic metal-based nano aluminum oxide particles were dispersed in 30 mL of ethanol and ultrasonically dispersed for 20 min, then 1.0 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

S2: Preparation of superhydrophobic suspension by phase separation method: 0.2 g of thermoplastic polyurethane elastomer particles were completely dissolved in 12 mL of ethyl acetate. Then, 0.25 g of superhydrophobic nano aluminum oxide particles were added and magnetically stirred for 3 h to uniformly disperse the superhydrophobic nano aluminum oxide particles. Then, 2.0 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

S3: Preparation of flexible armor structure: Anhydrous ethanol was used as a diluting solvent to prepare a diluent of an adhesive E44 and a curing agent polyether amine (the mass ratio of E44 to polyether amine was 1:1). At an air pressure of 0.3 MPa, the diluent was sprayed onto the surface of a Q235 carbon steel substrate to prepare an adhesive layer. Then, regenerated rubber particles from waste tires of 60-65 meshes were uniformly bonded on the surface (the dosage of the rubber particles was 268 g/m²), and a flexible armor structure was constructed after the rubber particles were completely cured.

S4: Preparation of highly stable superhydrophobic composite material with flexible armor structure for metal corrosion prevention: The superhydrophobic suspension prepared in S2 was sprayed onto the surface of the flexible armor structure prepared in S3 by a spray gun (the spraying pressure was 0.3 MPa, the spraying distance was 15 cm, and the dosage of the suspension was 1.0 mL/cm²), and a highly stable superhydrophobic composite material with flexible armor structure for metal corrosion prevention was prepared after complete curing.

The performance test method of the highly stable superhydrophobic composite material with flexible armor structure for metal corrosion prevention obtained in Example 8 was the same as that in Example 1. Test results were:

1. Wetting performance of coating: The contact angle and rolling angle of the water droplets on the coating surface were measured by the contact angle measuring instrument, the water contact angle of the coating surface was 157.1°, and the rolling angle was 4.9°. It can be seen that the prepared highly stable superhydrophobic composite material with flexible armor structure for metal corrosion prevention shows an excellent superhydrophobic characteristic.

2. Mechanical stability test of coating: (1) After the coating was worn for 1200 times with 2000-mesh sandpaper under a load condition of 100 g, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being worn for 1200 times with the sandpaper, and has excellent mechanical wear resistance. (2) After the coating was stripped for 450 times with a 3M tape, the contact angle of the water droplets was greater than 150°, and the rolling angle was less than 10°. It can be seen that the prepared highly stable superhydrophobic composite material with flexible armor structure for metal corrosion prevention still shows a better superhydrophobic characteristic for the water droplets after being stripped for 450 times with the 3M tape, and has excellent coating adhesion.

3. Corrosion resistance test-electrochemical impedance spectroscopy test of coating: The results showed that the charge transfer resistance of the coating was R_{ct}=9.11×10¹⁰ Ωcm², which was increased by 7 orders of magnitude compared to a blank Q235 carbon steel substrate (R_{ct}=1.18×10³ Ωcm²), showing better anti-corrosion and corrosion-resistant performance.

### Comparative Example 1

1. 5.0 g of hydrophilic metal-based nano aluminum oxide particles were dispersed in 30 mL of ethanol and ultrasonically dispersed for 20 min, then 1.0 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

2. 0.2 g of thermoplastic polyurethane elastomer particles were completely dissolved in 12 mL of ethyl acetate. Then, 0.25 g of superhydrophobic nano aluminum oxide particles were added, and magnetic stirring was performed for 3 h to uniformly disperse the superhydrophobic nano aluminum oxide particles. Then, 2.0 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared. The suspension was sprayed onto the surface of a Q235 carbon steel substrate to obtain a superhydrophobic coating with a surface layer only.

The performance test method of the comparative coating sample obtained in Comparative Example 1 was the same as that in Example 1, and test results were:

1. Wetting performance of coating: Water droplets were dropped onto the coating surface, and the contact angle measuring instrument was used for obtaining a water contact angle of the coating surface of 159.3° and a rolling angle of 3.8°. It can be seen that the prepared surface-layer superhydrophobic coating has an excellent superhydrophobic characteristic.

2. Mechanical stability test of coating: (1) After the coating was worn for 85 times with 2000-mesh sandpaper under a load condition of 100 g, the contact angle of the water droplets was less than 150°, and the rolling angle was greater than 10°. It can be seen that the prepared surface-layer superhydrophobic coating loses the superhydrophobic characteristic after being worn at a certain strength, and has poor mechanical wear resistance. (2) After the coating was stripped for 40 times with a 3M tape, the contact angle of the water droplets was less than 150°, and the rolling angle was greater than 10°. It can be seen that the prepared surface-layer superhydrophobic coating loses the superhydrophobic characteristic after being stripped at a certain strength with the tape, and the adhesion between the coating and the substrate was poor.

3. Corrosion resistance test-electrochemical impedance spectroscopy test of coating: The results showed that the charge transfer resistance of the coating was R_{ct}-8.69×10⁷ Ωcm², which was reduced by 3 orders of magnitude compared to the highly stable superhydrophobic composite material with flexible armor structure for metal corrosion prevention in Example 1 (R_{ct}=9.53×10¹⁰ Ωcm²), the electrochemical performance was weakened, and the anti-corrosion and corrosion-resistant performance was significantly reduced.

According to the test results of Comparative Example 1, it can be seen that due to the lack of an epoxy bonding layer and a flexible armor structure, the mechanical wear resistance of the coating was significantly reduced, and the corrosion resistance was significantly reduced. However, in the present disclosure, by introducing the epoxy bonding layer and the flexible armor structure, the mechanical wear resistance and corrosion resistance of the composite material coating were significantly improved.

### Comparative Example 2

1. 5.0 g of hydrophilic metal-based nano aluminum oxide particles were dispersed in 30 mL of ethanol and ultrasonically dispersed for 20 min, then 1.0 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

2. 0.2 g of thermoplastic polyurethane elastomer particles were completely dissolved in 12 mL of ethyl acetate. Then, 0.25 g of superhydrophobic nano aluminum oxide particles were added, and magnetic stirring was performed for 3 h to uniformly disperse the superhydrophobic nano aluminum oxide particles. Then, 2.0 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

3. Epoxy resin and a curing agent polyamide (650) thereof were respectively weighed in a weight ratio of 1:1 and diluted in 20 mL of ethanol under a magnetic stirring condition to prepare an epoxy diluent, then, the above epoxy diluent was sprayed onto the surface of a pre-treated Q235 carbon steel substrate material by a spray gun, and subsequently, a surface-layer superhydrophobic suspension was sprayed onto the surface thereof to obtain a superhydrophobic coating with an epoxy bonding layer and a superhydrophobic surface layer.

The performance test method of the comparative coating sample obtained in Comparative Example 2 was the same as that in Example 1, and test results were:

1. Wetting performance of coating: Water droplets were dropped onto the coating surface, and the contact angle measuring instrument was used for obtaining a water contact angle of the coating surface of 158.9° and a rolling angle of 4.0°. It can be seen that the prepared coating has an excellent superhydrophobic characteristic.

2. Mechanical stability test of coating: (1) After the coating was worn for 130 times with 2000-mesh sandpaper under a load condition of 100 g, the contact angle of the water droplets was less than 150°, and the rolling angle was greater than 10°. It can be seen that the prepared surface-layer superhydrophobic coating loses the superhydrophobic characteristic after being worn at a certain strength, and has poor mechanical wear resistance. (2) After the coating was stripped for 60 times with a 3M tape, the contact angle of the water droplets was less than 150°, and the rolling angle was greater than 10°. It can be seen that the prepared surface-layer superhydrophobic coating loses the superhydrophobic characteristic after being stripped at a certain strength with the tape, and the adhesion between the coating and the substrate was poor.

3. Corrosion resistance test-electrochemical impedance spectroscopy test of coating: The results showed that the charge transfer resistance of the coating was R_{ct}=9.66×10⁸ Ωcm², which was reduced by 2 orders of magnitude compared to the highly stable superhydrophobic composite material with flexible armor structure for metal corrosion prevention in Example 1 (R_{ct}=9.53×10¹⁰ Ωcm²), the electrochemical performance was weakened, and the anti-corrosion and corrosion-resistant performance was significantly reduced.

According to the test results of Comparative Example 2, it can be seen that due to the lack of a flexible armor structure, the mechanical wear resistance of the coating was significantly reduced, and the corrosion resistance was significantly reduced. However, in the present disclosure, by introducing the flexible armor structure, the mechanical wear resistance and corrosion resistance of the composite material coating were significantly improved.

### Comparative Example 3

1. 5.0 g of hydrophilic metal-based nano aluminum oxide particles were dispersed in 30 mL of ethanol and ultrasonically dispersed for 20 min, then 1.0 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

2. 0.2 g of thermoplastic polyurethane elastomer particles were completely dissolved in 12 mL of ethyl acetate. Then, 0.05 g of superhydrophobic nano aluminum oxide particles were added, and magnetic stirring was performed for 3 h to uniformly disperse the superhydrophobic nano aluminum oxide particles. Then, 2.0 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

3. Anhydrous ethanol was used as a diluting solvent to prepare a diluent of an adhesive E44 and a curing agent polyamide (the mass ratio of E44 to polyamide was 1:1). At an air pressure of 0.3 MPa, the diluent was sprayed onto the surface of a Q235 carbon steel substrate to prepare an adhesive layer. Then, regenerated rubber particles from waste tires of 60-65 meshes were uniformly bonded on the surface (the dosage of the rubber particles was 268 g/m²), and a flexible armor structure was constructed after the rubber particles were completely cured.

4. The superhydrophobic suspension prepared in 2 was sprayed onto the surface of the flexible armor structure prepared in 3 by a spray gun (the spraying pressure was 0.3 MPa, the spraying distance was 15 cm, and the dosage of the suspension was 1.0 mL/cm²), and a comparative coating sample was prepared after complete curing.

The performance test method of the comparative coating sample obtained in Comparative Example 3 was the same as that in Example 1, and test results were:

Wetting performance of coating: Water droplets were dropped onto the coating surface, and the contact angle measuring instrument was used for obtaining a water contact angle of the coating surface of 136.1°. It can be seen that the prepared comparative coating sample does not have a superhydrophobic characteristic.

According to the test results of Comparative Example 3, it can be seen that the dosage of the hydrophobic modified nanoparticles has a significant impact on the superhydrophobic performance of the coating, and a too low concentration can cause that the coating sample cannot achieve the superhydrophobic performance.

### Comparative Example 4

1. 5.0 g of hydrophilic metal-based nano aluminum oxide particles were dispersed in 30 mL of ethanol and ultrasonically dispersed for 20 min, then 0.1 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

2. 0.2 g of thermoplastic polyurethane elastomer particles were completely dissolved in 12 mL of ethyl acetate. Then, 0.25 g of superhydrophobic nano aluminum oxide particles were added, and magnetic stirring was performed for 3 h to uniformly disperse the superhydrophobic nano aluminum oxide particles. Then, 2.0 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

3. Anhydrous ethanol was used as a diluting solvent to prepare a diluent of an adhesive E44 and a curing agent polyamide (the mass ratio of E44 to polyamide was 1:1). At an air pressure of 0.3 MPa, the diluent was sprayed onto the surface of a Q235 carbon steel substrate to prepare an adhesive layer. Then, regenerated rubber particles from waste tires of 60-65 meshes were uniformly bonded on the surface (the dosage of the rubber particles was 268 g/m²), and a flexible armor structure was constructed after the rubber particles were completely cured.

4. The superhydrophobic suspension prepared in 2 was sprayed onto the surface of the flexible armor structure prepared in 3 by a spray gun (the spraying pressure was 0.3 MPa, the spraying distance was 15 cm, and the dosage of the suspension was 1.0 mL/cm²), and a comparative coating sample was prepared after complete curing.

The performance test method of the comparative coating sample obtained in Comparative Example 4 was the same as that in Example 1, and test results were:

Wetting performance of coating: Water droplets were dropped onto the coating surface, and the contact angle measuring instrument was used for obtaining a water contact angle of the coating surface of 132.6°. It can be seen that the prepared comparative coating sample does not have a superhydrophobic characteristic.

According to the test results of Comparative Example 4, it can be seen that the dosage of the hydrophobic modifier has a significant impact on the superhydrophobic performance of the coating, and a too low dosage can cause that the coating sample cannot achieve the superhydrophobic performance.

### Comparative Example 5

1. 5.0 g of hydrophilic metal-based nano aluminum oxide particles were dispersed in 30 mL of ethanol and ultrasonically dispersed for 20 min, then 1.0 mL of 1H, 1H, 2H, 2H-perfluorodecyltrimethoxysilane was added under a magnetic stirring condition, the mixture was continuously stirred under a room temperature condition for reacting for 1 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

2. 0.2 g of thermoplastic polyurethane elastomer particles were completely dissolved in 12 mL of ethyl acetate. Then, 0.25 g of superhydrophobic nano aluminum oxide particles were added, and magnetic stirring was performed for 3 h to uniformly disperse the superhydrophobic nano aluminum oxide particles. Then, 2.0 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

3. Anhydrous ethanol was used as a diluting solvent to prepare a diluent of an adhesive E44 and a curing agent polyamide (the mass ratio of E44 to polyamide was 1:1). At an air pressure of 0.3 MPa, the diluent was sprayed onto the surface of a Q235 carbon steel substrate to prepare an adhesive layer. Then, regenerated rubber particles from waste tires of 60-65 meshes were uniformly bonded on the surface (the dosage of the rubber particles was 268 g/m²), and a flexible armor structure was constructed after the rubber particles were completely cured.

4. The superhydrophobic suspension prepared in 2 was sprayed onto the surface of the flexible armor structure prepared in 3 by a spray gun (the spraying pressure was 0.3 MPa, the spraying distance was 15 cm, and the dosage of the suspension was 1.0 mL/cm²), and a comparative coating sample was prepared after complete curing.

The performance test method of the comparative coating sample obtained in Comparative Example 5 was the same as that in Example 1, and test results were:

Wetting performance of coating: Water droplets were dropped onto the coating surface, and the contact angle measuring instrument was used for obtaining a water contact angle of the coating surface of 141.3°. It can be seen that the prepared comparative coating sample does not have a superhydrophobic characteristic.

According to the test results of Comparative Example 5, it can be seen that the low-surface-energy modification reaction time has a significant impact on the superhydrophobic modification of the nanoparticles, and a too short time can cause that the coating cannot achieve the superhydrophobic performance.

### Comparative Example 6

1. 5.0 g of hydrophilic metal-based nano aluminum oxide particles were dispersed in 30 mL of ethanol and ultrasonically dispersed for 20 min, then 1.0 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

2. 0.2 g of thermoplastic polyurethane elastomer particles were completely dissolved in 12 mL of ethyl acetate. Then, 0.25 g of superhydrophobic nano aluminum oxide particles were added, and magnetic stirring was performed for 3 h to uniformly disperse the superhydrophobic nano aluminum oxide particles. Then, 2.0 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

3. Anhydrous ethanol was used as a diluting solvent to prepare a diluent of an adhesive E44 and a curing agent polyamide (the mass ratio of E44 to polyamide was 1:1). At an air pressure of 0.3 MPa, the diluent was sprayed onto the surface of a Q235 carbon steel substrate to prepare an adhesive layer. Then, regenerated rubber particles from waste tires of 100-110 meshes were uniformly bonded on the surface (the dosage of the rubber particles was 268 g/m²), and a flexible armor structure was constructed after the rubber particles were completely cured.

4. The superhydrophobic suspension prepared in 2 was sprayed onto the surface of the flexible armor structure prepared in 3 by a spray gun (the spraying pressure was 0.3 MPa, the spraying distance was 15 cm, and the dosage of the suspension was 1.0 mL/cm²), and a comparative coating sample was prepared after complete curing.

The performance test method of the comparative coating sample obtained in Comparative Example 6 was the same as that in Example 1, and test results were:

1. Wetting performance of coating: Water droplets were dropped onto the coating surface, and the contact angle measuring instrument was used for obtaining a water contact angle of the coating surface of 156.7° and a rolling angle of 5.1°. It can be seen that the prepared coating has an excellent superhydrophobic characteristic.

2. Mechanical stability test of coating: (1) After the coating was worn for 180 times with 2000-mesh sandpaper under a load condition of 100 g, the contact angle of the water droplets was less than 150°, and the rolling angle was greater than 10°. It can be seen that the prepared surface-layer superhydrophobic coating loses the superhydrophobic characteristic after being worn at a certain strength, and has poor mechanical wear resistance. (2) After the coating was stripped for 85 times with a 3M tape, the contact angle of the water droplets was less than 150°, and the rolling angle was greater than 10°. It can be seen that the prepared surface-layer superhydrophobic coating loses the superhydrophobic characteristic after being stripped at a certain strength with the tape, and the adhesion between the coating and the substrate was poor.

3. Corrosion resistance test-electrochemical impedance spectroscopy test of coating: The results showed that the charge transfer resistance of the coating was R_{ct}=6.92×10⁹ Ωcm², which was reduced by 1 order of magnitude compared to the highly stable superhydrophobic composite material with flexible armor structure for metal corrosion prevention in Example 1 (R_{ct}=9.53×10¹⁰ Ωcm²), the electrochemical performance was weakened, and the anti-corrosion and corrosion-resistant performance was significantly reduced.

According to the test results of Comparative Example 6, it can be seen that due to a too small size of the flexible armor structure, the mechanical wear resistance of the coating was significantly reduced, and the corrosion resistance was slightly reduced. However, in the present disclosure, by introducing a flexible armor structure with a suitable size, the mechanical wear resistance and corrosion resistance of the composite material coating were significantly improved.

### Comparative Example 7

1. 5.0 g of hydrophilic metal-based nano aluminum oxide particles were dispersed in 30 mL of ethanol and ultrasonically dispersed for 20 min, then 1.0 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

2. 0.2 g of thermoplastic polyurethane elastomer particles were completely dissolved in 12 mL of ethyl acetate. Then, 0.25 g of superhydrophobic nano aluminum oxide particles were added, and magnetic stirring was performed for 3 h to uniformly disperse the superhydrophobic nano aluminum oxide particles. Then, 2.0 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

3. Anhydrous ethanol was used as a diluting solvent to prepare a diluent of an adhesive E44 and a curing agent polyamide (the mass ratio of E44 to polyamide was 1:1). At an air pressure of 0.3 MPa, the diluent was sprayed onto the surface of a Q235 carbon steel substrate to prepare an adhesive layer. Then, regenerated rubber particles from waste tires of 40-50 meshes were uniformly bonded on the surface (the dosage of the rubber particles was 268 g/m²), and a flexible armor structure was constructed after the rubber particles were completely cured.

4. The superhydrophobic suspension prepared in 2 was sprayed onto the surface of the flexible armor structure prepared in 3 by a spray gun (the spraying pressure was 0.3 MPa, the spraying distance was 15 cm, and the dosage of the suspension was 1.0 mL/cm²), and a comparative coating sample was prepared after complete curing.

The performance test method of the comparative coating sample obtained in Comparative Example 7 was the same as that in Example 1, and test results were:

1. Wetting performance of coating: Water droplets were dropped onto the coating surface, and the contact angle measuring instrument was used for obtaining a water contact angle of the coating surface of 156.7° and a rolling angle of 5.1°. It can be seen that the prepared coating has an excellent superhydrophobic characteristic.

2. Mechanical stability test of coating: (1) After the coating was worn for 120 times with 2000-mesh sandpaper under a load condition of 100 g, the contact angle of the water droplets was less than 150°, and the rolling angle was greater than 10°. It can be seen that the prepared surface-layer superhydrophobic coating loses the superhydrophobic characteristic after being worn at a certain strength, and has poor mechanical wear resistance. (2) After the coating was stripped for 65 times with a 3M tape, the contact angle of the water droplets was less than 150°, and the rolling angle was greater than 10°. It can be seen that the prepared surface-layer superhydrophobic coating loses the superhydrophobic characteristic after being stripped at a certain strength with the tape, and the adhesion between the coating and the substrate was poor.

3. Corrosion resistance test-electrochemical impedance spectroscopy test of coating: The results showed that the charge transfer resistance of the coating was R_{ct}=4.85×10⁹ Ωcm², which was reduced by 1 order of magnitude compared to the highly stable superhydrophobic composite material with flexible armor structure for metal corrosion prevention in Example 1 (R_{ct}=9.53×10¹⁰ Ωcm²), the electrochemical performance was weakened, and the anti-corrosion and corrosion-resistant performance was significantly reduced.

According to the test results of Comparative Example 7, it can be seen that due to a too large size of the flexible armor structure, the mechanical wear resistance of the coating was significantly reduced, and the corrosion resistance was slightly reduced. However, in the present disclosure, by introducing a flexible armor structure with a suitable size, the mechanical wear resistance and corrosion resistance of the composite material coating were significantly improved.

### Comparative Example 8

1. 5.0 g of hydrophilic metal-based nano aluminum oxide particles were dispersed in 30 mL of ethanol and ultrasonically dispersed for 20 min, then 1.0 mL of 1H, 1H, 2H, 2H-perfluorodecyltrimethoxysilane was added under a magnetic stirring condition, the mixture was continuously stirred under a room temperature condition for reacting for 12 h (this process involves superhydrophobic modification of superhydrophilic metal-based nano aluminum oxide particles through fluorosilane hydrolytic condensation reaction), and the obtained suspension was dried to prepare superhydrophobic nano aluminum oxide particles.

2. 0.2 g of thermoplastic polyurethane elastomer particles were completely dissolved in 12 mL of ethyl acetate. Then, 0.25 g of superhydrophobic nano aluminum oxide particles were added, and magnetic stirring was performed for 3 h to uniformly disperse the superhydrophobic nano aluminum oxide particles. Then, 2.0 mL of ethanol was added as a non-solvent to achieve non-solvent induced TPU phase separation, magnetic stirring was performed for 15 min, and ultrasonic treatment was performed for 15 min. Finally, a uniform surface-layer superhydrophobic suspension was successfully prepared.

3. Anhydrous ethanol was used as a diluting solvent to prepare a diluent of an adhesive E44 and a curing agent polyamide (the mass ratio of E44 to polyamide was 1:1). At an air pressure of 0.3 MPa, the diluent was sprayed onto the surface of a Q235 carbon steel substrate to prepare an adhesive layer. Then, regenerated rubber particles from waste tires of 60-65 meshes were uniformly bonded on the surface (the dosage of the rubber particles was 268 g/m²), and a flexible armor structure was constructed after the rubber particles were completely cured.

4. The superhydrophobic suspension prepared in 2 was sprayed onto the surface of the flexible armor structure prepared in 3 by a spray gun (the spraying pressure was 0.3 MPa, the spraying distance was 15 cm, and the dosage of the suspension was 0.1 mL/cm²), and a comparative coating sample was prepared after complete curing.

The performance test method of the comparative coating sample obtained in Comparative Example 8 was the same as that in Example 1, and test results were:

Wetting performance of coating: Water droplets were dropped onto the coating surface, and the contact angle measuring instrument was used for obtaining a water contact angle of the coating surface of 139.2°. It can be seen that the prepared comparative coating sample does not have a superhydrophobic characteristic.

According to the test results of Comparative Example 8, it can be seen that the dosage of the suspension has a certain impact on the superhydrophobic performance of the coating, and a too low dosage can cause that the coating cannot achieve the superhydrophobic performance.

What is claimed is:

1. A method for preparing a highly stable superhydrophobic composite material with flexible armor structure for metal corrosion prevention, comprising the following steps:
S1: preparation of superhydrophobic modified nanoparticles: ultrasonically dispersing hydrophilic nanoparticles in an organic solvent, and then, adding a low-surface-energy organosilane coupling agent under a stirring condition for superhydrophobic modification to obtain superhydrophobic modified nanoparticles, wherein the volume ratio of the low-surface-energy organosilane coupling agent to the organic solvent is 0.05:3-0.15:3, and the mass concentration of the nanoparticles is 0.10-0.30 g/mL; and in S1, the reaction condition for modification is a room temperature, and the reaction time is 6-24 h;
S2: preparation of superhydrophobic suspension by phase separation method: completely dissolving polyester in the organic solvent, then adding the superhydrophobic modified nanoparticles under a stirring condition until the superhydrophobic modified nanoparticles are completely dispersed by stirring, adding a non-solvent to induce phase separation after the superhydrophobic nanoparticles are completely dispersed, and preparing a superhydrophobic suspension after the completion of phase separation, wherein the polyester is one or more of polyurethane, thermoplastic polyurethane, and Si-modified polyester; the organic solvent is one or more of ethyl acetate, butyl acetate, and acetone; the mass concentration of the polyester is 0.01-0.10 g/mL; and the non-solvent for inducing phase separation is anhydrous ethanol, and the volume ratio of the non-solvent to the organic solvent is 0.10-0.20 mL/mL;
S3: preparation of flexible armor structure: diluting an epoxy resin adhesive in the organic solvent to prepare an epoxy diluent, then spraying the epoxy diluent onto the surface of a pre-treated metal substrate by a spray method to prepare an epoxy adhesive layer, subsequently uniformly bonding flexible armor particles onto the surface of the epoxy adhesive layer, and performing curing to prepare a flexible armor structure, wherein the flexible armor particles are regenerated rubber particles from waste tires, the particle size is 60-65 meshes, and the dosage of the flexible armor particles is 100-300 g/m²; and
S4: preparation of highly stable superhydrophobic composite material with flexible armor structure for metal corrosion prevention: spraying the superhydrophobic suspension prepared in S2 onto the surface of the flexible armor structure prepared in S3 by a spray gun, and preparing a highly stable superhydrophobic composite material with flexible armor structure for metal corrosion prevention after complete curing.

2. The method for preparing a highly stable superhydrophobic composite material with flexible armor structure for metal corrosion prevention according to claim 1, wherein
in step S1, the nanoparticles are one or more of nano aluminum oxide particles, nano silicon dioxide particles, nano titanium dioxide particles, and nano zirconium dioxide particles; and the low-surface-energy organosilane coupling agent is one or more of 1H, 1H, 2H, 2H-perfluorodecyltrimethoxysilane, 1H, 1H, 2H, 2H-perfluorooctyltrimethoxysilane, or 1H, 1H, 2H, 2H-perfluorodecyltriethoxysilane.

3. The method for preparing a highly stable superhydrophobic composite material with flexible armor structure for metal corrosion prevention according to claim 1, wherein
in step S2, the mass concentration of the superhydrophobic modified nanoparticles is 0.01-0.10 g/mL.

4. The method for preparing a highly stable superhydrophobic composite material with flexible armor structure for metal corrosion prevention according to claim 1,
wherein in step S3, the epoxy resin adhesive is formed by mixing epoxy resin and a curing agent in a mass ratio of 1:1, wherein the curing agent is polyamide, polyether amine, diethylenetriamine, or γ-aminopropyltriethoxysilane.

5. The method for preparing a highly stable superhydrophobic composite material withflexible armor structure for metal corrosion prevention according to claim 1, wherein in step S3, the mass fraction of the epoxy resin adhesive in the epoxy diluent is 20%-30%.

6. The method for preparing a highly stable superhydrophobic composite material with flexible armor structure for metal corrosion prevention according to claim 1, wherein in step S4, the superhydrophobic suspension is sprayed onto the surface of the flexible armor structure by a spray method, and the dosage of the superhydrophobic suspension is 0.60-1.20 mL/cm²
